(19) United States
(12) Patent Application Publication
(10) Pub. No.: US 2002/0012377 A1
(43) Pub. Date: Jan. 31, 2002

(54) External resonant laser

(76) Inventors: Hiroshi Suganuma, Ibaraki (JP); Michio Oka, Tokyo (JP)

Correspondence Address: Sonnenschein, Nath & Rosenthal, Wacker Drive Station - Sears Tower, P.O. Box #061080, Chicago, IL, 60606, US

(21) Appl. No.: 09/821,955

(22) Filed: Mar. 30, 2001

(30) Foreign Application Priority Data
Mar. 31, 2000 (JP) P2000-100038
Mar. 31, 2000 (JP) P2000-10039

(51) Int. Cl. H01S 3/08

(52) U.S. Cl. 372/98

(57) ABSTRACT

Disclosed herein is an external resonant laser that comprises a laser oscillator and an external resonator. The laser oscillator emits a laser beam of a specific wavelength. The external resonator resonates the laser beam emitted from the laser oscillator. The external resonator contains a photopolymer volume hologram. The photopolymer volume hologram diffracts the laser beam emitted from the laser oscillator, applies the laser beam into an optical system provided in the external resonator and allows the passage of a laser beam of a prescribed wavelength. The laser beam of the prescribed wavelength is output from the external resonant laser.

### RELATED APPLICATION DATA

The present application claims priority to Japanese Applications Nos. P2000-100038 filed Mar. 31, 2000, and P2000-100039 filed Mar. 31, 2000, which applications are incorporated herein by reference to the extent permitted by law.

### BACKGROUND OF THE INVENTION

The present invention relates generally to a laser, more particularly to a laser that comprises an optical resonator incorporating a distribution optical element composed of a volume hologram.

External resonant semiconductor lasers are known, which have an external resonator that feeds back the output light. An external resonant semiconductor laser can emit a beam that has a wavelength falling within a narrow range. Moreover, it can emit an intense beam more easily than other semiconductor lasers such as distribution feedback (DFB) lasers and distributed Bragg reflector (DBR) lasers. In addition, the external resonant semiconductor laser can change the wavelength of the beam by, for example, rotating a mirror or a diffraction grating. Thanks to these advantages, the external resonant semiconductor laser finds various uses. It is used in wavelength-multiplex optical communication, wavelength conversion implemented by use of nonlinear optical effect, laser cooling, frequency standardization, spectrometric measuring for controlling environment or processes, interferometers, and the like. At present external resonant semiconductor lasers are commercially available.

Typical examples of a resonator is the Littman type shown in FIG. 1 and the Littrow type shown in FIG. 2. (As to the Littman resonator, refer to Micheal G. Littman and Harold Metcalf, “Spectrally narrow pulsed dye laser without beam expander,” Applied Optics. 17. 2224, 1978, Michael G. Littman, “Single-mode operation of grating-incident pulsed dye laser,” Optics Letters 3. 38, 1978 and K. C. Hervey and C. J. Myatt, “External-cavity diode laser using a grazing-incident diffraction grating,” Optics Letters, 16. 910, 1991.) As shown in FIG. 2, the Littrow resonator comprises a laser 2, a collimator lens 3, and a blazed diffraction grating 18. The grating 18 is designed such that the diffracted light beam of a specific order (usually, first order) travels exactly in the same optical path ofthe incident light having a particular wavelength. The laser 2 emits a beam, and the collimator lens 3 converts the beam to a parallel one. The parallel beam is applied to the blazed diffraction grating 18. The grating 18 diffracts the beam, distributing beams. These beams are applied back to the resonator ofthe laser 2. Thus, an external oscillator is constructed, which envelops an internal resonator. Of the beams distributed by the grating 18, only the beam of a specified wavelength is amplified.

In the Littman resonator, too, a beam of a specified wavelength can be selected from the beams distributed by the diffraction grating. As can be understood from FIG. 1, the inclination angle of the external mirror 4 may be changed to control the wavelength of a beam that is applied back to the internal resonator. The Littman resonator therefore serves to provide a wavelength-variable laser.

An external resonant laser cannot be put to practical use unless its output and wavelength are stabilized. To stabilize the output and wavelength, it is required that the external resonator and the internal resonator should emit light beams of the same wavelength. Various methods have been proposed, which control the wavelengths of the beams emitted from the internal resonator and external resonator. Among these methods are an electrical control that uses liquid crystal cells (see J. Struck: meier et al., “Electronically tunable external-cavity laser diode,” Optics Letters, 24. 1573, 1999). Another of these methods is a control that employs a feedback (see Jpn. Pat. Appln. Laid-Open Publication No.7-30180), another of these methods is a control that employs a micro-machine (see Jpn. Pat. Appln. Laid-Open Publication No. 11-307879, Jpn. Pat. Appln. Laid-Open Publication No. 10-209552, and the like). Still another of these methods is a method that utilizes a confocal optical system to facilitate the adjustment (see B. E. Bernacki et al., “Aligment-insensitive technique for wideband tuening of an unmodified semiconductor laser,” Optics Letters. 13. 725. 1988, Jpn. Pat. Appln. Laid-Open Publication No. 11-503877). A further example of such a method is one that stabilizes the frequency by using the reflected light selected in accordance with the resonance of the resonator (see B. Dahmani et al., “Frequency stabilization of semiconductor lasers by resonant optical feedback,” Optics Letters, 12. 876, 1987.) Another of these methods is one in which a mirror is rotated around a specified position, thereby accomplishing an accurate positioning (see U.S. Pat. No. 5,319,668).

The method of selecting a beam of a specified wavelength from the beams distributed by a diffraction grating is often employed not only in semiconductor lasers, but also in gas lasers such as CO₂ laser and Ar ion laser, excimer lasers, dye lasers and wavelength-variable solid-state lasers such as Ti-saphire laser. It is generally difficult, however, to manufacture diffraction gratings that have a diffraction efficiency exceeding 90%. Even those designed as glazed gratings can hardly attain so high a diffraction efficiency. Such a high-efficiency diffraction grating, if any, would be expensive. In the various methods described above, some control must be performed, and the external resonator used is inevitably complex in structure.

A display having a grating that is driven by a micro-machine has been recently developed. The display, known as “grating light valve (GLV),” can display seamless images that are clearer and brighter than the images displayed by means of the conventional spatial modulator. The GLV attracts much attention, because it can be manufactured at low cost by utilizing micro-machine technology and can operate at high speeds. The laser beam applied in such a display must be stabilized in terms of wavelength range. Of the three primary colors of light, i.e., red, green and blue, red is most perceptible to human eyes. For example, red light having a wavelength of 650 nm has a luminosity factor that is about 2.5 times as great as the luminosity factor of red light having a wavelength of 630 nm. That is, when people observe the 650 nm red light, they feel the light 2.5 times as bright as the same amount of 630-nm red light. Hence, it is required of a laser to emit a beam that is stable in wavelength despite temperature changes, so that the beam may represent any desired color.

With an external resonant laser it is possible to generate a coherent beam of a shorter wavelength by means of wavelength conversion in an external resonant semiconductor laser. (See W. J. Kozlovsky et al., “Generation of 41 mW of blue radiation by frequency doubling of a GaAlAs diode laser,” Applied Physics Letters 56(23), Jun. 4, 1990 and Jpn. Pat. Appln. Laid-Open Publication No. 10-506724.) The wavelength conversion renders it easy to provide laser beams having desired wavelengths, because the oscillation wavelengths of semiconductor lasers extend over a broad range. To effect direct wavelength conversion of lasers, however, various optical components are required. Among these optical components are an anamorphic prism for correcting the aspect ratio of the laser; a dichroic mirror for separating the wavelength-changed light from the fundamental wave; and a blazed grating for distributing the light. The greater the number of optical components used, the higher the probability for stray light, leading to a loss of energy. Additionally, the light may travel back to the semiconductor laser, destabilizing the operation of the external resonant laser. It is therefore demanded that an external resonator be simplified in structure, by reducing the number of the optical parts it incorporates.

The external resonance laser has but a low finesse. In order to enhance the efficiency of wavelength conversion in the resonator, it is necessary to reduce the energy loss and confine light within the resonator. However, the blazed grating employed to select a wavelength has an operating efficiency of only about 80%. Power enhancement cannot be achieved in the resonator to a desired degree. The operating efficiency of the blazed grating may be increased by the use of a nonlinear optical crystal that has a large non-linearity constant. Hitherto, however, nonlinear optical crystals exhibiting sufficient stability have not been found.

### BRIEF SUMMARY OF THE INVENTION

The present invention has been made in view of the foregoing. An object of the invention is to provide a laser that is simple and inexpensive and can yet generate a stable beam having a wavelength falling within a narrow range. Another object of the invention is to provide an external resonant semiconductor laser that can perform wavelength conversion at a high efficiency.

An external resonant semiconductor laser according to this invention comprises a laser oscillator and an external resonator. The laser oscillator emits a laser beam of a specific wavelength. The external resonator resonates the laser beam emitted from the laser oscillator. The external resonator contains a photopolymer volume hologram. The photopolymer volume hologram resonates the laser beam emitted from the laser oscillator, thus diffracting the laser beam. A laser beam having a desired wavelength is thereby emitted from the external resonant semiconductor laser.

According to the present invention there is provided a external resonant semiconductor laser that comprises a semiconductor laser oscillator and an external resonator. The semiconductor laser oscillator emits a laser beam of a specific wavelength. The external resonator converts the wavelength ofthe laser beam emitted from the semiconductor laser oscillator. The external resonator contains a volume hologram and a nonlinear optical crystal. The volume hologram diffracts the laser beam emitted from the laser oscillator and applies the same to the nonlinear optical crystal. The laser beam converted in wavelength passes through volume hologram and is emitted from the external resonant semiconductor laser.

Incorporating a photopolymer volume hologram, the external resonator has high wavelength selectivity. The external resonant semiconductor laser emits only a laser beam that has a wavelength very similar to the desired one. In other words, the laser emits a laser beam having a wavelength falling within a narrow range. Thanks to high diffraction efficiency of the photopolymer volume hologram, the laser emits a laser beam that has a desired wavelength.

The volume hologram incorporated in the external resonator performs the functions ofthree components, i.e., blazed diffraction grating, anamorphic prism, and diachroic mirror. Thus, the volume hologram replaces three components. This reduces the number of components of the external resonator. In addition, the volume hologram has high diffraction efficiency and high wavelength selectivity and can convert the aspect ratio of a laser beam at high efficiency. Therefore, the external resonant semiconductor laser can efficiently generate a laser beam that has a desired wavelength.

Moreover, the laser can generate a stable beam since the photopolymer volume hologram undergoes no aging.

As has been described in detail, the external resonant semiconductor laser according to this invention comprises a semiconductor laser oscillator and an external resonator. The semiconductor laser oscillator emits a laser beam of a specific wavelength. The external resonator converts the wavelength ofthe laser beam emitted from the semiconductor laser oscillator. The external resonator contains a volume hologram and a nonlinear optical crystal. The volume hologram diffracts the laser beam emitted from the laser oscillator and applies the same to the nonlinear optical crystal. The laser beam converted in wavelength passes through volume hologram and is emitted from the external resonant semiconductor laser.

The volume hologram incorporated in the external resonator performs the finctions of three components, i.e., blazed diffraction grating, anamorphic prism, and diachroic mirror. In other words, the volume hologram replaces three components. This means a reduction in the number of components of the external resonator. The external resonant semiconductor laser has but a small energy loss and can therefore operate at high reliability. The reduction of the number of components renders the external resonator simple and small and ultimately decreases the manufacturing cost of the external resonator. In addition, the volume hologram has high diffraction efficiency and high wavelength selectivity and can convert the aspect ratio of a laser beam at high efficiency. Therefore, the external resonant semiconductor laser can efficiently generate a laser beam that has a desired wavelength.

Hence, the present invention can provide a laser which is simple and inexpensive and which can yet efficiently convert the wavelength of a laser beam.

### BRIEF DESCRIPTION OF THE SEVERAL VIEWS OF THE DRAWING

FIG. 1 is a diagram showing a Littman resonator;

FIG. 2 is a diagram depicting a Littrow resonator;

FIG. 3 illustrates an external resonant semiconductor laser according to the first embodiment of the invention, which comprises a reflex photopolymer volume hologram;

FIG. 4 shows an external resonant semiconductor laser that comprises a laser oscillator, collimator lens and an epaxial volume hologram;

FIG. 5 shows an external resonant semiconductor laser according to the second embodiment of the present invention, which comprises a transmitting photopolymer volume hologram;

FIG. 6 depicts an external resonant semiconductor laser according to the third embodiment of the invention, which differs from the first embodiment in that a corner cube is used in place of the mirror shown in FIG. 3;

FIG. 7 illustrates an external resonant semiconductor laser according to the fourth embodiment of the invention, which differs from the first embodiment in that the reflex photopolymer volume hologram has a mirror at the mirror-side end and no mirror of the type shown in FIG. 3 is used;

FIG. 8 shows an external resonant semiconductor laser according to the fifth embodiment of the invention, which differs from the first embodiment in that the reflex photopolymer volume hologram has a corner cube at the mirror-side end and no mirror of the type shown in FIG. 3 is used;

FIG. 9 depicts an external resonant semiconductor laser according to the sixth embodiment of the invention, which comprises a collimator lens and a volume hologram provided in the collimator lens;

FIG. 10 represents an external resonant semiconductor laser according to the seventh embodiment of the invention, which comprises a volume hologram used as the window of a semiconductor laser package and a laser oscillator combined with the volume hologram;

FIG. 11 is a diagram explaining how a laser beam having a wavelength λ₁ is applied to record interference fringes in a photopolymer volume hologram;

FIG. 12 is a diagram explaining how a laser beam having a wavelength λ₂ is applied to reproduce interference fringes from the photopolymer volume hologram;

FIG. 13 is a diagram showing a correction optical system that is arranged between a mirror for applying a reference beam and a photopolymer volume hologram, in order to record interference fringes;

FIG. 14 shows another external resonant semiconductor laser according to the present invention;

FIG. 15 is a cross-sectional view of a volume hologram;

FIG. 16 is a diagram explaining how the volume hologram changes an aspect ratio;

FIG. 17 shows the first modification of the external resonant semiconductor laser shown in FIG. 14;

FIG. 18 illustrates the second modification of the external resonant semiconductor laser shown in FIG. 14;

FIG. 19 is a diagram depicting the third modification ofthe semiconductor laser shown in FIG. 14;

FIG. 20 is a diagram showing the fourth modification of the external resonant semiconductor laser shown in FIG. 14;

FIG. 21 shows a further external resonant semiconductor laser according to the present invention;

FIGS. 22 is a diagram illustrating the fifth modification of the external resonant semiconductor laser shown in FIG. 14;

FIG. 23 is a diagram depicting the sixth modification of the external resonant semiconductor laser shown in FIG. 14; and

FIG. 24 is a diagram showing the seventh modification ofthe external resonant semiconductor laser shown in FIG. 14.

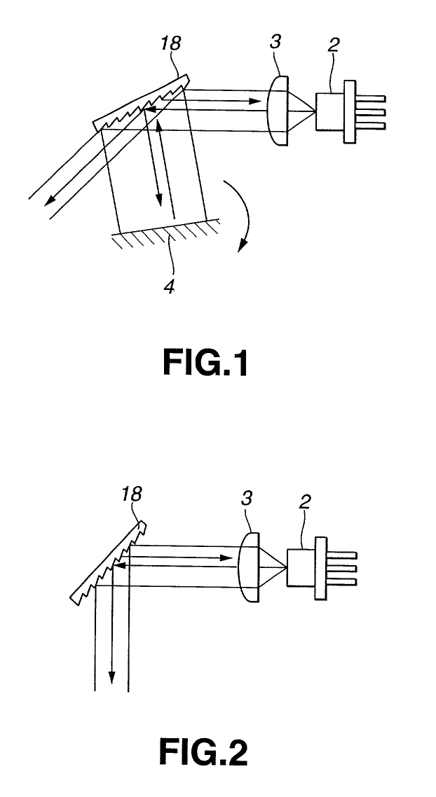

### DETAILED DESCRIPTION OF THE INVENTION

Embodiments of the present invention will be described with reference to the accompanying drawings. Nonetheless, the invention is not limited to the embodiments to be described below. Rather, various changes and modifications can be made without departing from the scope and spirit of this invention.

(First Embodiment)

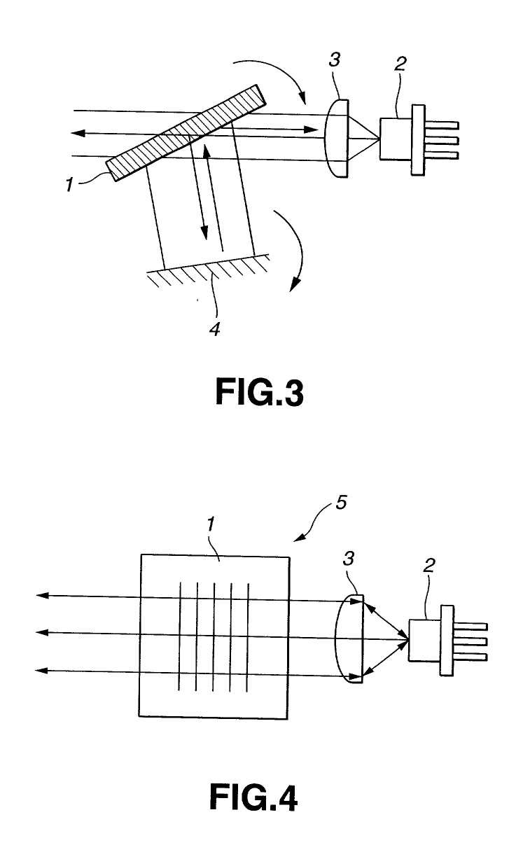

FIG. 3 shows an external resonant semiconductor laser, which is the first embodiment of the invention and which comprises a reflex photopolymer volume hologram 1. The external resonant semiconductor laser further comprises a laser oscillator 2, a collimator lens 3, a reflex photopolymer volume hologram 1, and a mirror 4. The laser oscillator 2 emits a laser beam of a prescribed wavelength. The collimator lens 3 converts the laser beam to a parallel beam. The parallel beam is applied to the reflex photopolymer volume hologram 1, which is a distribution optical element.

In the external resonant semiconductor laser, the hologram 1 and the mirror 4 constitute an external resonator. The collimator lens 3 receives the laser beam from the laser oscillator 2 and converts it to a parallel beam, which is applied to the reflex photopolymer volume hologram 1. The hologram 1 diffracts the parallel beam in a predetermined direction. The mirror 4 reflects the beam thus diffracted, applying the beam back to the reflex photopolymer volume hologram 1. Due to the wavelength selectivity of the hologram 1, only a laser beam having a specified wavelength returns to the laser oscillator 2. Beams of any other wavelengths are emitted in a prescribed direction as output light.

The external resonant semiconductor laser is characterized by the reflex photopolymer volume hologram 1, which is used in place of a blazed diffraction grating that is a distribution optical element usually incorporated in the external resonator. The volume hologram 1 exhibits wavelength selectivity much higher than that of the blazed diffraction grating. Moreover, the hologram 1 has a spatial frequency as high as thousands of lines per millimeter. The photopolymer volume hologram 1, employed in place of a blazed diffraction grating, can enhance the performance of the external resonant semiconductor laser.

Having high wavelength selectivity, the volume hologram 1 can narrow the range of wavelength for the laser beam. Thus, the hologram 1 can increase the coherence length of the laser beam emitted from the external resonant semiconductor laser. This helps to provide a high spatial frequency and a high diffraction efficiency, both higher than those of a blazed diffraction grating commonly used in external resonators. Hence, the external resonator can exhibit higher wavelength selectivity than external resonators that have a blazed diffraction grating each.

Since the external resonator has its wavelength selectivity thus enhanced, it is possible to reduce the range of wavelength for the laser beam emitted from the laser oscillator 2. In other words, the emission of beams having wavelengths other than the desired one can be controlled, making it possible to emit only a laser beam that has a wavelength very similar to the desired one.

The volume hologram 1 exhibits wavelength selectivity higher than that of the interference filter generally used, though lower than the wavelength selectivity of the Littman external resonator. The hologram 1 therefore serves to enhance the wavelength selectivity ofthe external resonator. In addition, like any type of a volume hologram, the hologram 1 has a high diffraction efficiency, increasing the finesse of the external resonator over that of the ordinary external resonator. This also serves to raise the wavelength selectivity of the external resonator.

Thus, the range of wavelength for the laser beam can be reduced further. That is, the wavelength of the laser beam is stabilized, falling within a narrow range. The visual characteristic of the laser beam is thereby improved. The external resonant semiconductor laser shown in FIG. 3 can therefore function as a light source fit for use in displays that excel in visual characteristic.

To make best use of the wavelength selectivity of the volume hologram, it suffices to apply the light from an object and the reference light in the opposite directions. If the wavelength selectivity of the volume hologram is best utilized, it is possible to provide such an external resonant seinconductor laser 5 as is illustrated in FIG. 4. As shown in FIG. 4, the laser 5 comprises an epaxial volume hologram 1, a laser oscillator 2 and a collimator lens 3. With this laser it is possible to simplify the external resonator and make the same smaller.

A volume hologram has selectivity with respect to transverse mode, too, thanks to its angle selectivity. Thus, the volume hologram can work in a stable transverse mode. If plane waves are used to record the volume hologram, only the plane-wave component of the incident light will be diffracted to reproduce the volume hologram. Even if higher-order waves that have no plane waves at their wave front are generated, the light will scarcely be diffracted. An energy loss, if any, will take place in the external resonator. Thus, only the plane-wave component is fed back into the internal resonator. The transverse mode is thereby selected. It is therefore possible to stabilize the transverse mode of the laser beam.

In ordinary uses, the resonant semiconductor laser should operate in the TEM00 fundamental mode. To generate a beam of a special shape, however, the waves need not be limited to plane waves.

Recently it has been proposed that a resonator should incorporate a diffraction optical element to generate a beam of a desired pattern. An effect similar to this can be attained by means of a volume hologram. Since the volume hologram has a high diffraction efficiency, it can achieve excellent control of the beam pattern. More specifically, the use of a volume hologram makes it possible to generate a laser beam called “top-hat beam” exhibiting unifonn intensity distribution, to correct the astigmatism of a semiconductor laser, and to change the divergence angle of a semiconductor laser so as to shape the beam into one having a circular cross section. A beam having such a special profile can be generated by recording the volume hologram so that the phase, diffraction efficiency, absorption, etc. of the hologram change spatially.

This invention employs a photopolymer volume hologram. Other types of volume holograms are known, among which is a crystal volume hologram that is made of lithium niobate crystal. The photopolymer volume hologram can be made in more different shapes than the crystal volume hologram. It can therefore fmd more uses than the crystal volume hologram, as will be described later. Further, the photopolymer volume hologram undergoes no aging, whereas the crystal volume hologram varies with time (the interference fringes disappear as the hologram is reproduced repeatedly). In view of this, the photopolymer volume hologram is a reliable distribution optical element.

Volume holograms can be classified into two types, i.e., reflex volume hologram and transmitting volume hologram. The present invention can use either type of a volume hologram.

The external resonant semiconductor laser according to the first embodiment of the invention, which has the above-mentioned features, can generate a laser beam which has a specific wavelength falling within a narrow range and which exhibits a stable transverse mode.

(Second Embodiment)

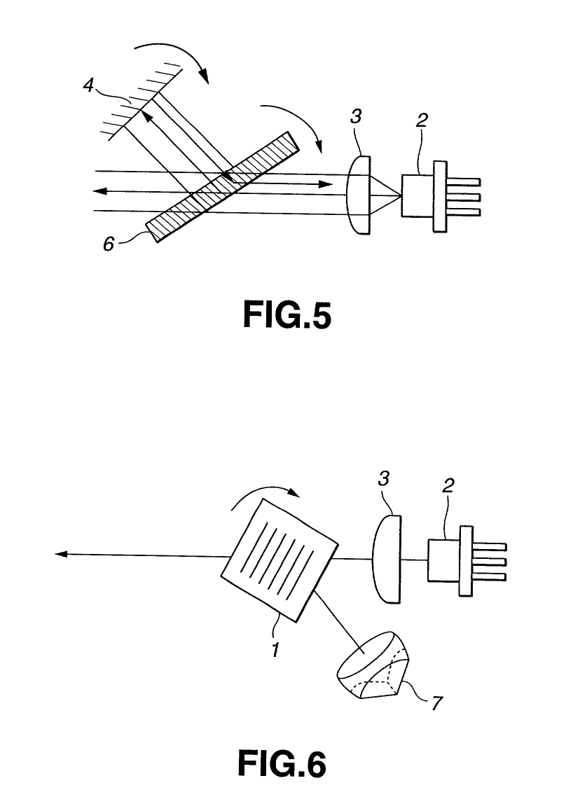

FIG. 5 shows an external resonant semiconductor laser according to the second embodiment of this invention, which utilizes a transmitting photopolymer volume hologram 6. This external resonant semiconductor laser comprises a laser oscillator 2, a collimator lens 3 and a mirror 4. The laser oscillator 1 emits a laser beam of a prescribed wavelength. The collimator lens 3 converts the laser beam to a parallel beam, which is applied to the transmitting photopolymer volume hologram 6.

In the external resonant semiconductor laser, the mirror 4 and the volume hologram 6 constitute an external resonator. The collimator lens 3 receives the laser beam from the laser oscillator 2 and converts it to a parallel beam, which is applied to the transmitting photopolymer volume hologram 6. The volume hologram 6 diffracts the beam, which is applied to the mirror 4. The iirror 4 reflects the beam, applying the same back to the transmitting photopolymer volume hologram 6. The volume hologram 6, which has wavelength selectivity, selects a laser beam of a prescribed wavelength, from the beam applied from the inirror 4. The laser beam selected travels to the laser oscillator 2, while the beams of any other wavelengths travel, as output light, in a specific direction.

Like the laser according to the first embodiment, the external resonant semiconductor laser, i.e., the second embodiment, can generate a laser beam which has a specific wavelength falling within a narrow range and which exhibits a stable transverse mode.

The diffraction efficiency of a reflex volume hologram gradually changes at the center angle when angle-phase mismatching happens or at the center wavelength when wavelength-phase mismatching takes place. This means that the reflex volume hologram has high wavelength selectivity and can therefore provide a relatively large angle tolerance. By contrast, the diffraction efficiency of a transmitting volume hologram sharply changes, not gradually as that of the reflex volume hologram. The reflex volume hologram is advantageous over the transmitting volume hologram, because it has high wavelength selectivity and can therefore provide a relatively large angle tolerance. Hence, the reflex volume hologram or the transmitting volume hologram may be used in accordance with the use, in consideration of their diffraction efficiencies that change differently in case of angle-phase mismatching or wavelength-phase mismatching.

(Third Embodiment)

In most Littman resonators, a mirror is located at one end of the external resonator. The mirror may be replaced by a corner cube. FIG. 6 shows an external resonant semiconductor laser according to the third embodiment ofthe invention. The third embodiment differs from the first embodiment in that the corner cube 7 is used in place of the mirror 4 used in the first embodiment.

As illustrated in FIG. 6, the external resonant semiconductor laser according to the third embodiment comprises a reflex photopolymer volume hologram 1, a laser oscillator 2 and a collimator lens 3, in addition to the corner cube 7. The laser oscillator 2 emits a laser beam of a prescribed wavelength. The collimator lens 3 converts the laser beam to a parallel beam, which is applied to the reflex photopolymer volume hologram 1.

In the external resonant semiconductor laser that is the third embodiment, the reflex photopolymer volume hologram 1 and the corner cube 7 constitute an external resonator. The collimator lens 3 receives the laser beam from the laser oscillator 2 and converts it to a parallel beam, which is applied to the reflex photopolymer volume hologram 1. The volume hologram 1 diffracts the beam in a predetermined direction. The corner cube 7 reflects the parallel beam, which is applied back to the reflex photopolymer volume hologram 1. The volume hologram 1, which has wavelength selectivity, selects a laser beam of a prescribed wavelength, from the beam applied from the corner cube 7. The laser beam selected travels to the laser oscillator 2, while the beams of any other wavelengths travel, as output light, in a specific direction.

The corner cube 7 reflects the incident beam in the direction exactly opposite to the direction of incidence. No measures need to be taken to align the beam reflected by the comer cube 7 with the beam incident to the corner cube 7. The wavelength of the beam can be changed by only rotating the volume hologram, in particular when the laser is used as a wavelength-variable laser. This helps to simplify the adjustment and movable mechanisms incorporated in the external resonant semiconductor laser.

Constructed as described above, the external resonant semiconductor laser that is the third embodiment can generate a laser beam which has a specific wavelength falling within a narrow range and which exhibits a stable transverse mode, in the same way as the external resonant semiconductor laser according to the first embodiment.

(Fourth Embodiment)

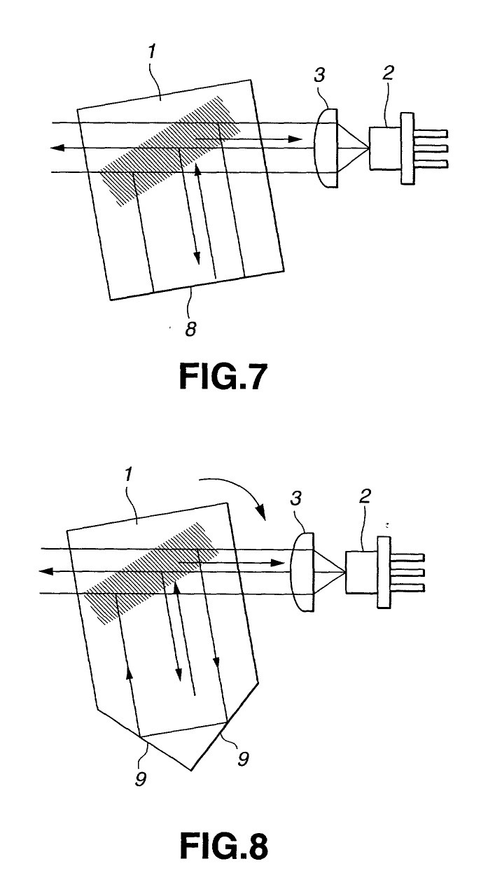

The semiconductor laser that is the first embodiment can be rendered monolithic by changing the shape of the volume hologram. If only a laser beam of a specific wavelength is used, that end of the reflex photopolymer volume hologram 1, which faces the mirror 4 may be mirror-polished and may reflect the beam. In this case, the mirror 4 can be dispensed with. FIG. 7 shows an external resonant semiconductor laser that is the fourth embodiment of the invention, which differs from the first embodiment in that one end of the reflex photopolymer volume hologram 1 is mirror-polished, forming a reflection surface 8 and that no mirrors are used at all.

As shown in FIG. 7, the external resonant semiconductor laser according to the fourth embodiment comprises a reflex photopolymer volume hologram 1, a laser oscillator 2 and a collimator lens 4. The laser oscillator 2 emits a laser beam of a specific wavelength. The collimator lens 3 converts the laser beam to a parallel beam, which is applied to the reflex photopolymer volume hologram 1.

That end of the hologram 1, which receives the beam diffracted in the hologram, is mirror-polished. In other words, that end of the hologram 1, which opposes the mirror 4 in the first embodiment, is mirror-polished, providing the reflection surface 8. The reflection surface 8 reflects the beam diffracted in the hologram 1, guiding the same back into the reflex photopolymer volume hologram 1. Therefore, the volume hologram 1 alone constitutes an external resonator in the external resonant semiconductor laser according to the fourth embodiment. Thus, the parallel beam that the collimator lens 3 has output by converting the laser beam eimtted from the laser oscillator 2 is applied to the reflex photopolymer volume hologram 1. In the hologram 1, the parallel beam is diffracted in one direction, then reflected from the reflection surface 8 and applied back to the interference fringes. Due to the wavelength selectivity of the hologram 1, only the laser beam of a prescribed wavelength is applied back to the laser oscillator 2. The beams of any other wavelengths travel, as output light, in a particular direction.

Having the structure described above, the external resonant semiconductor laser that is the fourth embodiment can generate a laser beam which has a specific wavelength falling within a narrow range and which exhibits a stable transverse mode, in the same way as the external resonant semiconductor laser according to the first embodiment. The fourth embodiment is simpler than the first to third embodiments, because only one component, i.e., the volume hologram 1, constitute the external resonator. Therefore, the fourth embodiment can be manufactured at a lower cost than the first to third embodiments.

(Fifth Embodiment)

FIG. 8 shows the fifth embodiment of the present invention. This embodiment is different from the first embodiment in two respects. First, the reflex photopolymer volume hologram 1 has one end processed to function as a corner cube. Second, this embodiment has no component that is equivalent to the mirror 4 used in the first embodiment.

As FIG. 8 shows, the external resonant semiconductor laser according to the fifth embodiment comprises a laser oscillator 2 and a collimator lens 4, besides the reflex photopolymer volume hologram 1. The laser oscillator 2 emits a laser beam, which is applied to the collimator lens 3. The collimator lens 3 converts the laser beam to a parallel beam. The parallel beam is applied to the reflex photopolymer volume hologram 1.

In the fifth embodiment, that end of the hologram 1, which receives the beam diffracted in the hologram, is mirror-polished in the form of a corner cube. More precisely, that end of the hologram 1, which opposes the mirror 4 in the first embodiment, is mirror-polished, providing a reflection surface 9. The reflection surface 9 reflects the beam diffracted in the hologram 1, guiding the same back into the reflex photopolymer volume hologram 1. Hence, the volume hologram 1 alone constitutes an external resonator in the external resonant semiconductor laser according to the fourth embodiment. The parallel beam that the collimator lens 3 has output by converting the laser beam emitted from the laser oscillator 2 is applied to the reflex photopolymer volume hologram 1. In the hologram 1, the parallel beam is diffracted in one direction, then reflected from the reflection surface 9 and applied back to the interference fringes. Since the hologram 1 has wavelength selectivity, only the laser beam of a prescribed wavelength is applied back to the laser oscillator 2. The beams of any other wavelengths travel, as output light, in a particular direction.

Thus constructed, the external resonant semiconductor laser according to the fifth embodiment can generate a laser beam which has a specific wavelength falling within a narrow range and which exhibits a stable transverse mode, in the same way as the external resonant semiconductor laser according to the first embodiment. The fifth embodiment is simpler in structure than the first to third embodiments, because only one component, i.e., the volume hologram 1, constitutes the external resonator. The firth embodiment can, therefore, be manufactured at a lower cost than the first to third embodiments.

The fifth embodiment thus structured can function as a wavelength-variable laser, only if the reflex photopolymer volume hologram 1 is rotated in a prescribed direction.

The volume hologram 1 may be formed within the collimator lens 3. In this case, the hologram 1 and the collimator lens 3 constitute an integrated unit.

(Sixth Embodiment)

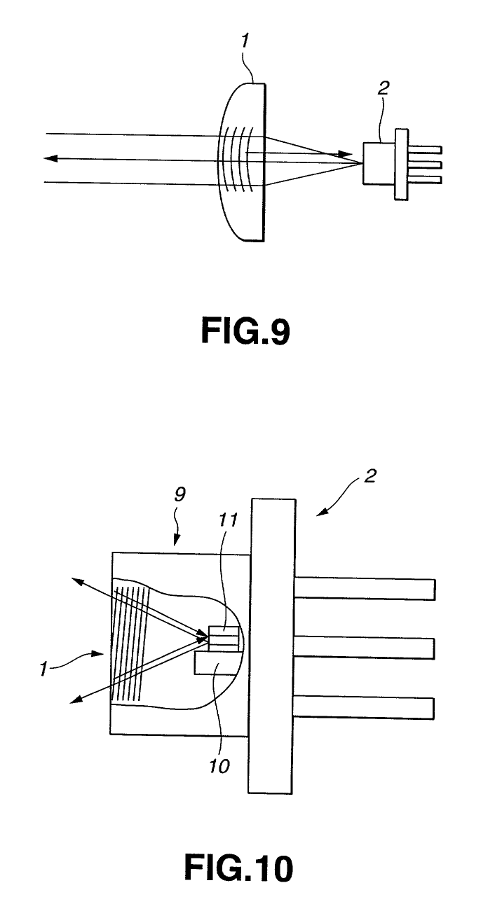

FIG. 9 depicts the sixth embodiment of the invention, which is an external resonant semiconductor laser. This semiconductor laser is characterized in that the reflex photopolymer volume hologram 1 is shaped like a collimator lens. As FIG. 9 shows, the sixth embodiment comprises a laser oscillator 2, besides the reflex photopolymer volume hologram 1. The collimator lens 3 emits a laser beam having a specific wavelength.

As described above, the volume hologram 1 is shaped like a collimator lens in the sixth embodiment. That is, a reflex photopolymer volume hologram and a collimator lens are combined into one unit. Namely, the photopolymer volume hologram 1 along constitutes the external resonator in the external resonant seimconductor laser according to the sixth embodiment.

The laser beam emitted from the laser oscillator 2 is applied to the photopolymer volume hologram 1 shaped like a collimator lens. Since the volume hologram 1 exhibits wavelength selectivity, only the laser beam of a prescribed wavelength is applied back to the laser oscillator 2 and undergoes resonation in the laser oscillator 2.

Thus constructed, the external resonant semiconductor laser according to the sixth embodiment can generate a laser beam which has a specific wavelength falling within a narrow range and which exhibits a stable transverse mode, in the same way as the external resonant semiconductor laser according to the first embodiment. The sixth embodiment is simpler in structure than the first to third embodiments, because only one component (i.e., the photopolymer volume hologram 1) constitutes the external resonator. The sixth embodiment can, therefore, be smaller and manufactured at a lower cost than the first to third embodiments.

According to the present invention, a volume hologram may be used as the window of a semiconductor laser package and may therefore be combined with a laser oscillator.

(Seventh Embodiment)

FIG. 10 represents an external resonant semiconductor laser according to the seventh embodiment of the invention, which uses a volume hologram as the window of a semiconductor laser package and in which the laser oscillator is combined with the volume hologram. As shown in FIG. 10, the seventh embodiment comprises a reflex photopolymer volume hologram 1 and a laser oscillator 2. The volume hologram 1 constitutes the window 10 of the package of the laser oscillator 2. That is, the laser oscillator 2 works as an external resonator, too, in the external resonant semiconductor laser according to the seventh embodiment.

The laser oscillator 2 comprises a Peltier element 11 and a laser element 12 mounted on the Peltier element 11. The reflex photopolymer volume hologram 1 is provided in the window 10 of the package of the laser oscillator 2. The laser element 12 emits a laser beam, which is applied to the volume hologram 1. Due to the wavelength selectivity of the volume hologram 1, only a laser beam having a specified wavelength returns to the laser oscillator 2.

The external resonant semiconductor lasers according to the first to seventh embodiments have a problem in their practical use. Namely, the resonator length changes with time due to vibration, temperature changes, air convection and the like. If the resonator length changes, the output of the laser will change. Nonetheless, this problem can be solved by various methods. More specifically, some measures are taken to minimize the vibration. The entire resonator may be shielded. The semiconductor laser may be mounted on a Peltier element to control the temperature. Further, the input current to the semiconductor laser may be controlled. Some of the optical elements, such as a mirror, may be mounted on an actuator such as a piezoelectric element or a voice coil motor, thereby to move the optical elements to desired positions in accordance with feedback signals.

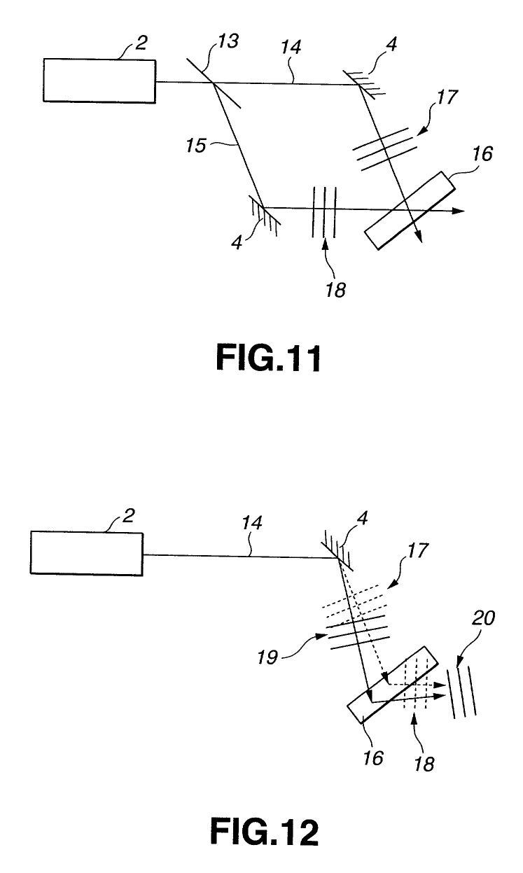

To record a volume hologram, a laser oscillator 2 applies a laser beam having a wavelength λ₁ to a beam splitter 13, as is illustrated in FIG. 11. The beam splitter 13 splits the laser beam to a reference beam 14 and an object beam 15. The reference beam 14 has a specific wave front. A mirror 4 reflects the reference beam 14, guiding the same to a photopolymer volume hologram 16. Another mirror 4 reflects the object beam 15, guiding the same to the volume hologram 16. As shown in FIG. 11, the reference beam 14 and object beam 15 have a wave front 17 and a wave front 18, respectively.

To reproduce the volume hologram, the laser oscillator 2 applies a laser beam having a wavelength λ₂ to the mirror 4 shown in FIG. 12. The mirror 4 reflects the beam, applying the same to the photopolymer volume hologram 16. In this case, a reference beam 14 and object beam 15 have a wave front 19 and a wave front 20, respectively, as is illustrated in FIG. 12.

The laser beam used need not have the same wavelength in both the process of recording the hologram and the process of reproducing the hologram. In other words, the wave fronts 17 and 19 the reference beam has when the hologram is recorded and reproduced need not be identical to each other. Simlarly, the wave fronts 18 and 20 the object beam has when the hologram is recorded and reproduced need not be identical to each other. In view of Bragg's phase-matching condition, however, it is desired that both the reference beam and the object beam be plane waves in the process of reproducing the hologram.

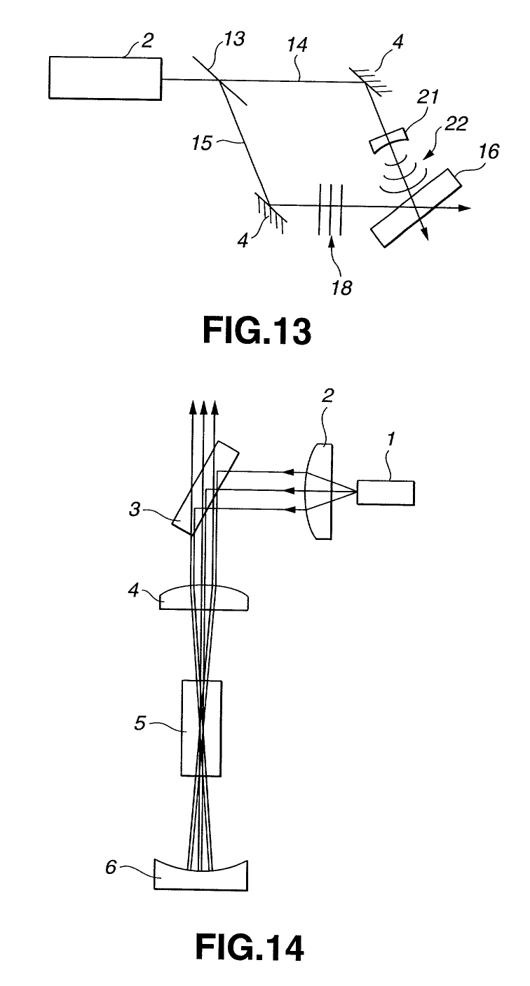

In the case of a photopolymer volume hologram, the laser beam applied to record interference fringes may differ in wavelength from the laser beam applied to reproduce the interference fringes, and a wave front 22 other than plane waves may be generated to reproduce the interference fringes. If so, the optical system for recording the fringes needs to have a correction optical element 21 that generates a given wave front, as is illustrated in FIG. 13. The correction optical element 21 may be one having aberration, such as a hologram, a non-spherical element, an eccentric element. Alternatively, the correction optical element 21 may be a spatial modulator, such as a diffraction-type element or a liquid crystal panel. The correction optical element 21 may be arranged, as shown in FIG. 13, between a mirror 4 for reflecting the reference beam 14 and the photopolymer volume hologram 16. Then, it is possible to record a hologram that has a desired wave front when it is reproduced.

All embodiments described above are semiconductor lasers. This is because semiconductor lasers can be small and reliable and can be manufactured in large numbers and, hence, at low cost. Nevertheless, the present invention is not limited to semiconductor lasers. Rather, the invention can be applied to other types of lasers, such as gas lasers (e.g., CO₂ laser and Ar ion laser), excimer lasers, dye lasers and wavelength-variable solid-state lasers (e.g., Ti-saphire laser). Moreover, this invention may be applied to resonators for use in these lasers or to feedback-controlled optical systems, achieving the same advantage as in various types of lasers. Any resonator according to the invention may be incorporated into any type of a laser, rendering the laser more advantageous than otherwise.

(Eighth Embodiment)

In the eighth embodiment of the invention, second harmonic waves are generated to accomplish wavelength conversion. FIG. 14 shows an external resonant semiconductor laser according to the eighth embodiment.

As FIG. 14 shows, this external resonant semiconductor laser comprises a semiconductor laser oscillator 1, a collimator lens 2, a volume hologram 3, a condensing lens 4, a nonlinear optical crystal 5, and an external resonator having a concave mirror.

The semiconductor laser oscillator 1 emits a laser beam having a specific wavelength. For example, the oscillator 1 is an InGaAs semiconductor laser that emits a laser beam having a wavelength of 920 nm. The term “laser beam having a wavelength of 920 nm” means a beam containing fluxes the wavelengths of which are approximately 920 nm. Note that any other wavelengths specified hereinafter are of the same definition. It is desired that the semiconductor laser oscillator 1 have an anti-reflection (AR) coating on its output end so that the output end may have reflectance of 0.001% or less.

The external resonant semiconductor laser shown in FIG. 14 is characterized in that the volume hologram 3 serves as the distribution optical element in the external resonator. The laser has no blazed diffraction grating that is generally used as a distribution optical element.

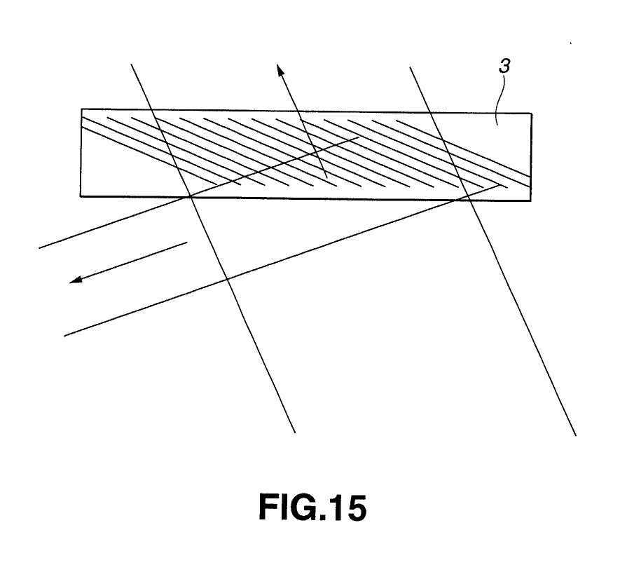

The volume hologram 3 is a three-dimensional diffraction grating that is inclined in a recording medium, as is illustrated in FIG. 15. It is desired that the diameter of the beam diffracted by the hologram 3 be reduced in the plane of diffraction. Generally, the divergence angle of a semiconductor laser is small in the direction parallel to the substrate and large in the direction perpendicular to the substrate. The volume hologram 3 exhibits wavelength selectivity and angle selectivity, both much higher than those of ordinary diffraction gratings. Further, the hologram 3 has a spatial frequency as high as thousands of lines per millimeter. The volume hologram 3, used in place of a blazed diffraction grating, can enhance the perfonnance of the external resonant semiconductor laser, as will be explained below.

First, the volume hologram 3 can narrow the range of wavelength for the laser beam, because it has high wavelength selectivity. Thus, the hologram 3 can increase the coherence length of the laser beam emitted from the external resonant semiconductor laser. This helps to provide a high spatial frequency and a high diffraction efficiency, both higher than those of a blazed diffraction grating coimnonly used in external resonators. Hence, the external resonator can exhibit higher wavelength selectivity than external resonators that have a blazed diffraction grating each.

The external resonator can thus have its wavelength selectivity enhanced. The range of wavelength for the laser beam can therefore be narrowed. That is, laser beams of wavelengths different from the desired one can be discarded. In other words, only the laser beams having wavelengths similar to the desired one can be extracted.

The volume hologram 3 exhibits wavelength selectivity higher than that of the interference filter generally used, though lower than the wavelength selectivity of the external resonator. The volume hologram 3 therefore serves increase the wavelength selectivity ofthe external resonator. Furthermore, like any type of a volume hologram, the hologram 3 has a high diffraction efficiency and can improve the finesse of the external resonator over that of the ordinary external resonator. This also helps to raise the wavelength selectivity of the external resonator.

Thus, the range of wavelength for the laser beam can be reduced further. That is, the wavelength of the laser beam is stabilized, falling within a narrow range. This improves the visual characteristic of the laser beam. The external resonant semiconductor laser shown in FIG. 14 can therefore function as a light source fit for use in displays that excel in visual characteristic.

The volume hologram 3 can function as a dichroic mirror that separates wavelength-changed light from the fundamental wave.

Secondly, the volume hologram 3 has selectivity with respect to transverse mode, too, thanks to its angle selectivity. Thus, the volume hologram 3 can operate in a stable transverse mode. If plane waves are used to record the volume hologram 3, only the plane-wave component of the incident light will be diffracted to reproduce the volume hologram. Even if higher-order waves that have no plane waves at their wave front are generated, the light will scarcely be diffracted. An energy loss, if any, will take place in the external resonator. Thus, only the plane-wave component is fed back into the internal resonator. The transverse mode is thereby selected. It is therefore possible to stabilize the transverse mode of the laser beam.

Thirdly, the volume hologram 3 can imparts an aspect ratio of almost 1:1 to the beam emitted from the semiconductor laser, only if it is designed to receive and diffract the laser beam in the plane that is perpendicular to the substrate of the semiconductor laser. The volume hologram 3 can therefore function as an anamorphic prism, too.

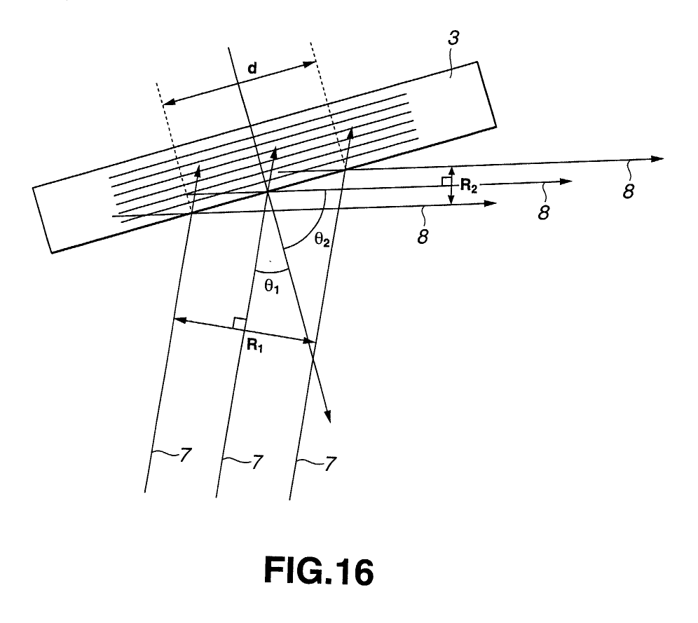

How the volume hologram 3 imparts such an aspect ratio to the laser beam and function as an anamorphic prism will be described, with reference to FIG. 16. As shown in FIG. 16, the first light beam 7 having a diameter R₁ is applied to the volume hologram 3 at an incidence angle θ₁. The volume hologram 3 diffracts the first light beam 7 and changes the aspect ratio thereof, generating the second light beam 8. The second light beam 8 is emitted from the volume hologram 3 at an emission angle θ₂ and has a diameter R₂ as it emerges from the hologram 3. In this case, the incidence angle θ₁ and the diameter R₁ have the relation represented by the following equation:

d cos θ₁=R₁

where d is the diameter that the first light beam 7 has when it reaches the volume hologram 3.

On the other hand, the incidence angle θ₂ and the diameter R₂ have the relation represented by the following equation:

d cos θ₂=R₂

where d is the diameter that the first light beam 7 has when it reaches the volume hologram 3.

As is obvious from these equations, the factor M of converting the aspect ratio of the volume hologram 3 can be given as follows:

M=R₂/R₂ =cos θ₂/cos θ₁

It should be noted that the diameter of the beam remains unchanged in the direction perpendicular to the plane of FIG. 16.

This equation indicates that the volume hologram 3 can emit a beam that has a cross section of expanded or contracted in one direction by the desired factor M, if appropriate directions are selected for two light fluxes in the process of recording the volume hologram 3. Thus, the volume hologram 3 can convert the aspect ratio of the beam. The seniconductor laser need not have conversion means such as an anamorphic prism.

As pointed out above, the volume hologram 3 functions as the distribution optical element in the external resonator, in place of a blazed diffraction grating that is generally used as a distribution optical element. Namely, the volume hologram 3 performs the functions of three components, i.e., anamorphic prism, diachroic mirror and blazed diffraction grating. The use of the volume hologram 3 simplifies the structure of the external resonator and, hence, reduces the size thereof.

Volume holograms are classified into two types in accordance with the material used, i.e., crystal volume hologram and photopolymer volume hologram. A crystal volume hologram is made of, for example, Fe:LiNbO₃ or the like. The present invention can use either type of a volume hologram.

Nonetheless, it is preferred that the volume hologram 3 be made of photopolymer, for two reasons. First, the photopolymer volume hologram can be made thicker than the crystal volume hologram; it can therefore be more freely designed in terms of shape and put to more uses. Second, the photopolymer volume hologram is superior to the crystal volume hologram in terms of aging characteristics and can therefore works as a reliable distribution optical element. That is, the interference fringes formed in the photopolymer volume hologram do not change with time, whereas those formed in the crystal volume hologram disappear in about b 20 hours.

Volume holograms can also be classified into two types, i.e., reflex volume hologram 1 and transmitting volume hologram 6. This invention can use either type of a volume hologram.

The diffraction efficiency of a reflex volume hologram gradually changes at the center angle when angle-phase mismatching happens or at the center wavelength when wavelength-phase mismatching takes place. This means that the reflex volume hologram has high wavelength selectivity and can therefore provide a relatively large angle tolerance. By contrast, the diffraction efficiency of a transmitting volume hologram sharply changes, not gradually as that of the reflex volume hologram. The reflex volume hologram is advantageous over the transmitting volume hologram, because it has high wavelength selectivity and can therefore provide a relatively large angle tolerance. Hence, the reflex volume hologram or the transmitting volume hologram may be used in accordance with the use, in consideration oftheir diffraction efficiencies that change differently in case of angle-phase mismatching or wavelength-phase mismatching.

The nonlinear optical crystal 5 shown in FIG. 14 converts the wavelength of the laser beam applied to it. The crystal 5 effects wavelength conversion in the external resonant semiconductor laser according to the eighth embodiment. The nonlinear optical crystal 5 may be made of BBO, CLBO, LBO, KTP, LiNbO₃, KnbO₃ or the like. The material is selected in accordance with the wavelength of the laser beam applied to the nonlinear optical crystal 5. The short-wavelength blue-emitting semiconductor laser, which has been developed in recent years and which is made of InGaN, can generate a beam having a wavelength of about 406 nm. If combined with the nonlinear optical crystal 5 of this invention, which is made of BBO,SBBO,KBBF, CLBO or the like, the short-wavelength blue-emitting semiconductor laser can provide a small, low-cost source of coherent light. The crystal 5 may be a bulk crystal. Alternatively, it may be made of lithium niobate to perform cyclic inversion of polarization. Table 1, presented below, shows other representative combinations of a nonlinear optical crystal and a semiconductor laser.

TABLE 1

| | | nonlinear optical crystal | KTP | MgO:LN | KnbO₃ | BBO | LBO | KDP | SBBO | KBBF | CLBO |
|---|---|---|---|---|---|---|---|---|---|---|---|
| | | shortest transmitting | 0.35 | 0.33 | 0.4 | 0.19 | 0.155 | 0.18 | 0.155 | 0.155 | 0.18 |
| | | wavelength (μm) | | | | | | | | | |
| oscillation | | longest transmitting | 4.5 | 5.5 | 4.5 | 3 | 2.6 | 1.7 | 3.8 | — | 2.75 |
| wavelength (μm) | | wavelength (μm) | | | | | | | | | |
| shortest | longest | shortest SHG transmitting | 495 | 400 | 420 | 205 | <277 | 266 | <200 | <184.7 | 235 |
| | | wavelength (μm) | | | | | | | | | |
| 1.2 | 1.6 | InGaAsP | ◯ | ◯ | ◯ | ◯ | ◯ | ◯ | ◯ | ◯ | ◯ |
| 0.75 | 0.9 | GaAIAs | Δ | Δ | Δ | ◯ | ◯ | ◯ | ◯ | ◯ | ◯ |
| 0.66 | 0.69 | InGaP | X | X | X | ◯ | ◯ | ◯ | ◯ | ◯ | ◯ |
| 0.42 | 0.39 | InGaN | X | X | X | Δ | X | X | ◯ | ◯ | X |

Some symbols are used in Table 1, indicating, as listed below, whether or not each nonlinear optical crystal can be combined with various semiconductor lasers, to provide practical light sources.

∘: The crystal can be combined with the laser.

Δ: The crystal can be combined with the laser, for some frequencies only.

×: The crystal can not be combined with the laser.

How the external resonant semiconductor laser, or the eighth embodiment, operates will be described below, with reference to FIG. 14.

The semiconductor laser oscillator 1 emits a laser beam, which is applied to the collimator lens 2. The collimator lens 2 converts the laser beam to a parallel beam. The parallel beam is applied to the volume hologram 3.

In the volume hologram 3 the laser beam is diffracted at a prescribed angle. The beam thus diffracted and converted in aspect ratio emerges from the volume hologram 3. The laser beam then converges as it passes through the condensing lens 4 and is then applied into converges into the nonlinear optical crystal 5. It should be noted that the beam has a specifically shaped cross section, because its aspect ratio has been changed to a predetermined value in the volume hologram 3.

In the nonlinear optical crystal 5, the laser beam is converted to second harmonic waves, that is, the laser beam having a wavelength of 920 nm is converted to the second harmonic waves having a wavelength of 460 nm. The second harmonic waves travel back to the hologram 3 directly. Alternatively, they first emerge from the nonlinear optical crystal 5, are reflected by a concave mirror 6 and travel back to the volume hologram 3. The concave mirror 6 will be described later.

After passing through the nonlinear optical crystal 5, the laser beam reaches the concave mirror 6 that functions as the external resonator.

The laser beam reflected by the concave mirror 6 travels backwards until it is applied to the volume hologram 3. The volume hologram 3 has wavelength selectivity, designed to diffract only the fundamental waves emitted from the semiconductor laser oscillator 1. Therefore, the hologram 3 does not diffract the second harmonic waves. The second harmonic waves pass through the hologram 3, without being diffracted. Namely, the volume hologram 3 functions as a dichroic filter, too.

Thus, the laser beam emitted from the semiconductor laser oscillator 1 and having a wavelength of 920 nm is converted to second harmonic waves having a wavelength of 460 nm. In other words, the eighth embodiment generates a coherent light beam.

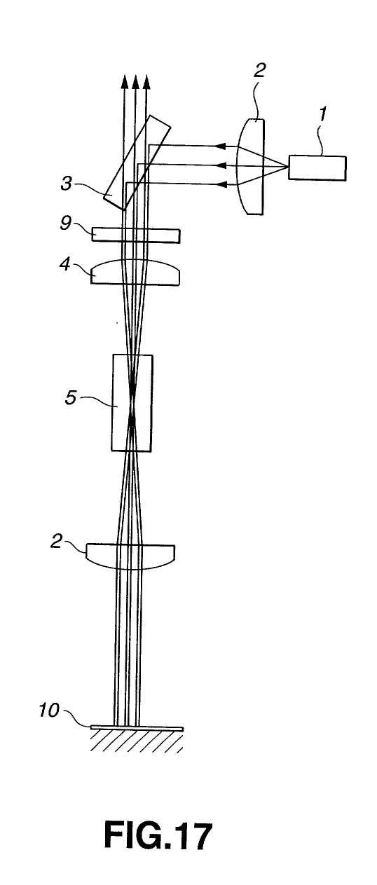

The eighth embodiment may be modified to control the direction of polarization, thereby to generate second harmonic waves. For example, a half-wavelength plate 9 may be used as shown in FIG. 17 to control the direction of polarization.

This external resonant semiconductor laser, or the first modification, differs from the eighth embodiment in three respects. First, the half-wavelength plate 9 is provided between the volume hologram 3 and the condensing lens 4. Second, a flat mirror 10 is used in place of the concave mirror 6. Third, the collimator lens 2 is arranged between the collimator lens 2 and the nonlinear optical crystal 5.

In the first modification of FIG. 17, the volume hologram 3 diffracts the laser beam. The half-wavelength plate 9 polarizes the laser beam in a prescribed direction. The condensing lens 4 makes the laser beam converge, thus applying the same to the nonlinear optical crystal 5. The volume hologram 3 changes the aspect ratio of the laser beam applied to the nonlinear optical crystal 5. The laser beam therefore has a specifically shaped cross section.

In the nonlinear optical crystal 5, the laser beam is converted to second harmonic waves. That is, the laser beam having a wavelength of 920 nm is changed to second harmonic waves having a wavelength of 460 nm. The second harmonic waves travel back toward the hologram 3. Alternatively, they first emerge from the nonlinear optical crystal 5, are converted to a parallel beam by a collimator lens 2 (later described), reflected by the flat mirror 10 and travel back to the volume hologram 3.

After passing through the nonlinear optical crystal 5, the laser beam reaches the flat mirror 10 that functions as the external resonator.

The laser beam reflected by the concave mirror 6 travels backwards, passing through the half-wavelength plate 9. The half-wavelength plate 9 polarizes the laser beam, setting the same in the initial direction, before the beam reaches the volume hologram 3. As in the eighth embodiment, the volume hologram 3 has wavelength selectivity, designed to diffract only the fundamental waves emitted from the semiconductor laser oscillator 1. Therefore, the hologram 3 does not diffract the second harmonic waves. The second harmonic waves pass through the hologram 3, without being diffracted.

Thus, the laser beam emitted from the semiconductor laser oscillator 1 and having a wavelength of 920 nm is converted to second harmonic waves having a wavelength of 460 nm. That is, the first modification of the eighth embodiment can generate a coherent light beam.

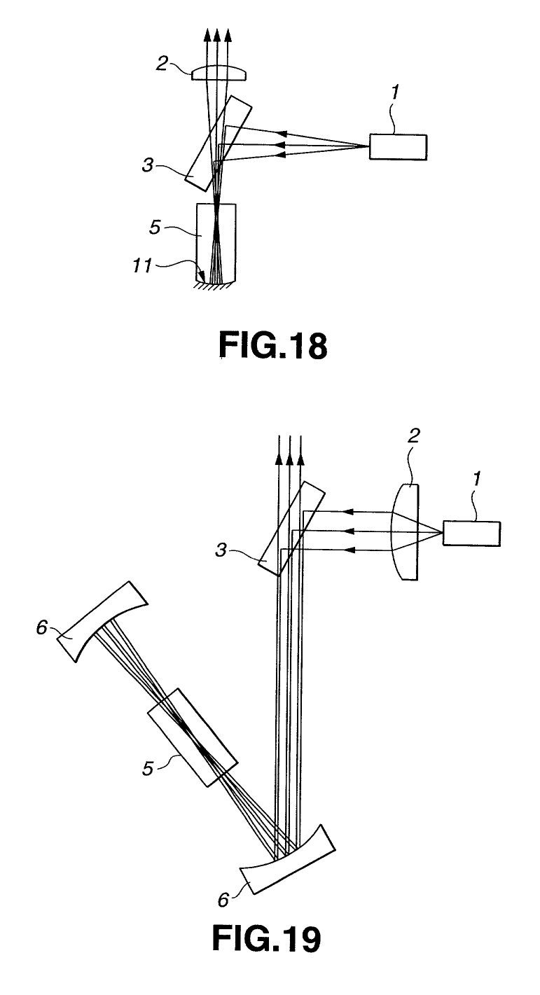

The eighth embodiment may be modified in another way, as is illustrated in FIG. 18.

The modification of FIG. 18, or the second modification, is different from the eighth modification (FIG. 14) in three respects. First, the condensing lens 4 and the concave mirror 6 are removed. Second, a collimator lens 2 is moved to the output side of the external resonator, from a point between the semiconductor laser oscillator 1 and the volume hologram 3. Third, the output end of the nonlinear optical crystal 5 is processed, forming a concave surface, and is coated with a reflecting film, thus providing an external resonator mirror 11.

In the second modification of the eighth embodiment, the laser beam emitted from the semiconductor laser oscillator 1 is directly applied to the volume hologram 3. The volume hologram 3 diffracts the laser beam in a specific angle. The nonlinear optical crystal 5 receives the laser beam thus diffracted. The laser beam converges in the nonlinear optical crystal 5. The volume hologram 3 converts the aspect ratio of the laser beam, which comes to have a specifically shaped cross section. In the nonlinear optical crystal 5, the laser beam is converted to second harmonic waves, that is, the laser beam having a wavelength of 920 nm is converted to second harmonic waves having a wavelength of 460 nm. The second harmonic waves directly travel to the volume hologram 3. Alternatively, the second harmonic waves pass through the nonlinear optical crystal 5, are reflected by the external resonator mirror 11 and travel to the volume hologram 3.

As in the eighth embodiment, the volume hologram 3 has wavelength selectivity, designed to diffract only the fundamental waves emitted from the semiconductor laser oscillator 1. Hence, the hologram 3 does not diffract the second harmonic waves. The second harmonic waves travel from the hologram 3 to the collimator lens 2. The collimator lens 2 converts the second harmonic waves into a parallel beam. The parallel beam is emitted from the external resonator.

Thus, the laser beam emitted from the semiconductor laser oscillator 1 and having a wavelength of 920 nm is converted to second harmonic waves having a wavelength of 460 nm. The second modification of the eighth embodiment can generate a coherent light beam.

The eighth embodiment may be still modified in another way, as shown in FIG. 19.

The modification of FIG. 19, or the third modification, is different from the eighth modification (FIG. 14) in three respects. First, the condensing lens 4 is removed from. Second, a concave mirror 6 is arranged between the volume hologram 3 and the nonlinear optical crystal 5. Third, the nonlinear optical crystal 5 and the concave mirror of the external resonator are changed in position.

In the third modification, the semiconductor laser oscillator 1 emits a laser beam. The collimator lens 2 converts the laser beam to a parallel beam. The parallel beam is applied to the volume hologram 3.

The volume hologram 3 diffracts the laser beam in a specified angle. The laser beam thus diffracted is applied to the concave mirror 6. The concave mirror 6 reflects the laser beam, which converges into the nonlinear optical crystal 5. The volume hologram 3 changes the aspect ratio of the laser beam to a prescribed value. The laser beam therefore attains a specifically shaped cross section.

The nonlinear optical crystal 5 converts the laser beam to second harmonic waves. That is, the laser beam having a wavelength of 920 nm is changed to second harmonic waves having a wavelength of 460 nm. The second harmonic waves travel toward the hologram 3. Alternatively, they pass through the nonlinear optical crystal 5 and are reflected by the concave mirror 6.

The laser beam reflected by the concave mirror 6 travels back to the volume hologram 3. Since the volume hologram 3 has wavelength selectivity as in the eighth embodiment, it does not diffract the second harmonic waves. The second harmonic waves pass through the hologram 3 to the external resonator, without being diffracted.

The laser beam emitted from the semiconductor laser oscillator 1 and having a wavelength of 920 nm is thus converted to second harmonic waves having a wavelength of 460 nm. The third modification of the eighth embodiment can therefore generate a coherent light beam.

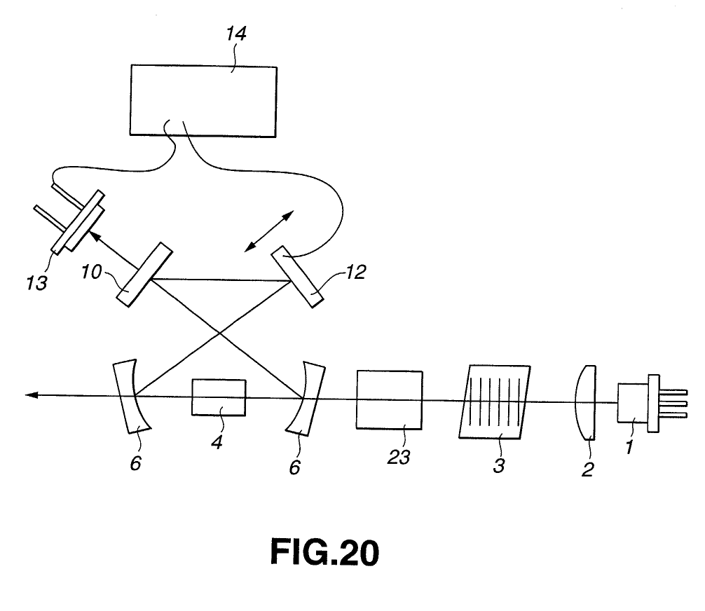

The eighth embodiment may be modified in another way, as is illustrated in FIG. 20.

The modification of FIG. 20, or the fourth modification, is different from the eighth modification (FIG. 14) in that the concave mirror 6, flat mirror 10 and nonlinear optical crystal 5 constitute a ring-shaped external resonator.

In the fourth modification, the semiconductor laser oscillator 1 emits a laser beam. The collimator lens 2 converts the laser beam to a parallel laser beam, which is applied to the volume hologram 3.

The volume hologram 3 diffracts the laser beam in a specific angle. The laser beam thus diffracted is fed back to the semiconductor laser oscillator 1.

The laser beam also emerges from the volume hologram 3 and converges into the nonlinear optical crystal 23. The nonlinear optical crystal 23 converts the laser beam to second harmonic waves. That is, the laser beam having a wavelength of 920 nm is changed to second harmonic waves having a wavelength of460 nm. The second harmonic waves pass through the concave mirror 6 and emitted outwards.

As shown in FIG. 20, the fourth modification has a flat mirror 10, an actuator 12, a photodetector 13, and a servo control circuit 14. These components perform feedback control on the resonator length, thereby to enhance the coupling effect ofthe beam emitted from a Littrow external resonant semiconductor laser.

The laser beam emitted from the semiconductor laser oscillator 1 and having a wavelength of 920 nm is thus converted to second harmonic waves having a wavelength of 460 nm. The fourth modification of the eighth embodiment can therefore generate a coherent light beam.

(Ninth Embodiment)

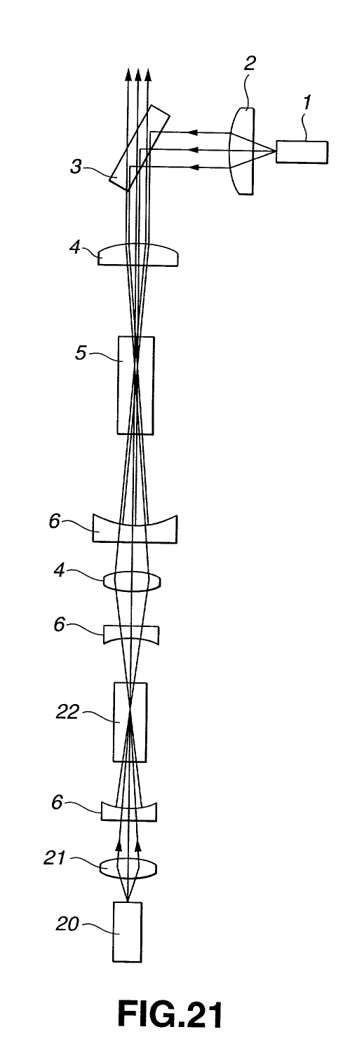

According to the present invention, frequency mixing may be effected to accomplish frequency conversion. FIG. 21 shows the ninth embodiment of the invention, or an external resonant semiconductor laser in which frequency mixing is carried out.

The ninth embodiment is a combination of the eighth embodiment (FIG. 14), a solid-state laser oscillator and an optical system for the solid-state laser. As seen from FIG. 21, the solid-state laser oscillator is a semiconductor laser 20, and the optical system comprises a condensing lens 4, two concave mirrors 6, a condensing lens 21 and a laser crystal 22.

The semiconductor laser oscillator 1 is, for example, a GaAlAs laser that emits a laser beam having a wavelength of 810 nm. It is desired that the semiconductor laser oscillator 1 have an anti-reflection (AR) coating on its output end provided so that the output end may have reflectance of 0.001% or less.

The solid-state laser oscillator emits a laser beam of a specific wavelength. It is, for example, an Nd:YAG laser or an Nd:YVO₄ laser, which emits a coherent light beam having a wavelength of 1064 nm.

The concave mirror 6 provided between the condensing lens 4 and the nonlinear optical crystal 5 has a coating that exhibits a high reflectance to the laser beam having a wavelength of 810 nm and a high transmittance to the laser beam having a wavelength of 1064 nm. Hence, the beam emitted from the solid-state laser oscillator 20 may be efficiently applied into the nonlinear optical crystal 5.

The laser beam emitted from the semiconductor laser oscillator 1 travels in the same way as in the eighth embodiment. On the other hand, the laser beam emitted from the solid-state laser oscillator 20 is applied to the concave mirror 6 arranged near the nonlinear optical crystal 5, after passing through the condensing lens 21, concave mirror 6, laser crystal 22, concave mirror 6 and the condensing lens 4. As mentioned above, the concave mirror 6 provided between the condensing lens 4 and the nonlinear optical crystal 5 has a coating that exhibits a high reflectance to the 810 nm laser beam and a high transmittance to the 1064 nm laser beam. Therefore, the beam emitted from the solid-state laser oscillator 20 and having a wavelength of 1064 nm passes through this concave mirror 6 and is applied to the nonlinear optical crystal 5. The nonlinearly optical crystal 5 mixes the 810 nm beam emitted from the semiconductor laser oscillator 1 with the 1064 nm beam emitted from the solid-state laser oscillator 20, generating a coherent beam having a wavelength of 460 nm. The 460-nm beam passes through the volume hologram 3 and is output to the external resonator.

Thus, the 810 nm beam emitted from the semiconductor laser oscillator 1 and the 1064 nm beam emitted from the solid-state laser oscillator 20 are subjected to frequency mixing. A coherent beam having a wavelength of 460 nm is thereby obtained.

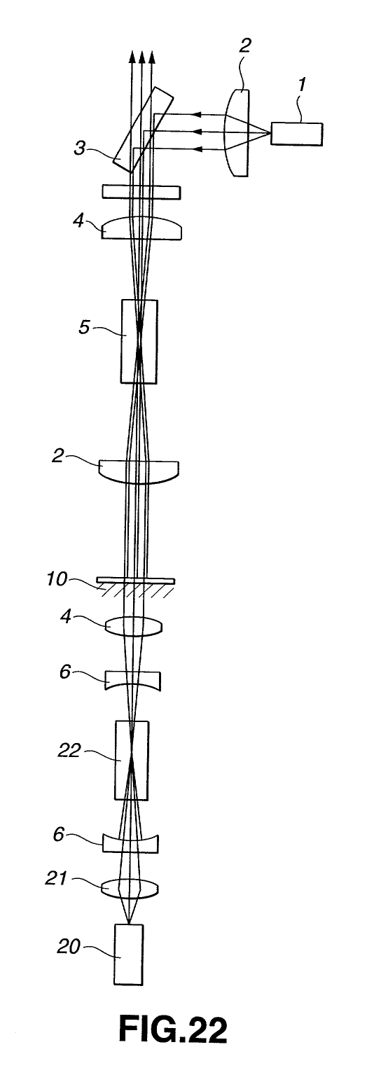

The eighth embodiment may be modified, as is illustrated in FIG. 22, providing the fifth modification of the eighth embodiment (FIG. 14).

The fifth modification of FIG. 22 is different from the first modification (FIG. 17) in that a half-wavelength plate, a solid-state laser oscillator and an optical system for the solid-state laser oscillator are provided additionally. More specifically, a half-wavelength plate 9, a solid-state laser oscillator 20, a condensing lens 21, a concave mirror 6, a laser crystal 22, a flat mirror 10, and a condensing lens 4.

As in the ninth embodiment, the semiconductor laser oscillator 1 is an GaAlAs laser that emits a laser beam having a wavelength of 810 nm and the solid-state laser oscillator 20 is an Nd:YAG laser or an Nd:YVO₄ laser that emits a coherent light beam having a wavelength of 1064 nm.

As in the embodiment 9, the flat mirror 10 arranged between the collimator lens 2 and the condensing lens 4 has a coating that exhibits a high reflectance to the laser beam having a wavelength of 810 nm and a high transinittance to the laser beam having a wavelength of 1064 nm. Therefore, the beam emitted from the solid-state laser oscillator 20 is efficiently applied into the nonlinear optical crystal 5.

The laser beam emitted from the semiconductor laser oscillator 1 travels in the same way as in the first modification. On the other hand, the laser beam emitted from the solid-state laser oscillator 20 is applied to the flat mirror 10 after passing through the condensing lens 21, concave mirror 6, laser crystal 22, concave mirror 6 and the condensing lens 4. As mentioned above, the concave mirror 10 has a coating that exhibits a high reflectance to the 810 nm laser beam and a high transmittance to the 1064 nm laser beam. Therefore, the beam emitted from the solid-state laser oscillator 20 and having a wavelength of 1064 nm passes through the flat mirror 10 and is applied to the nonlinear optical crystal 5. The nonlinearly optical crystal 5 mixes the 810 nm beam emitted from the semiconductor laser oscillator 1 with the 1064 nm beam emitted from the solid-state laser oscillator 20, generating a coherent beam having a wavelength of 460 nm. The 460 nm beam passes through the volume hologram 3 and is output to the external resonator.

Thus, the 810 nm beam emitted from the semiconductor laser oscillator 1 and the 1064 nm beam emitted from the solid-state laser oscillator 20 are subjected to frequency mixing. A coherent beam having a wavelength of 460 nm is thereby obtained.

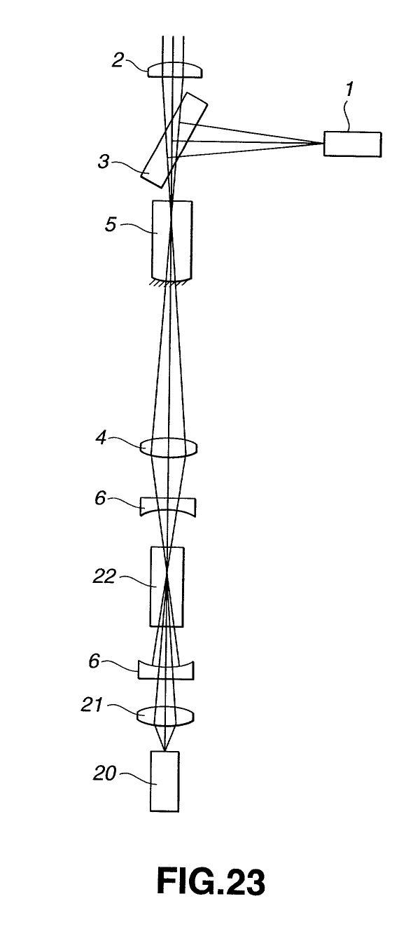

The eighth embodiment may be modified in another way, as is illustrated in FIG. 23, thus providing the sixth modification of the eighth embodiment (FIG. 14).

The sixth modification of FIG. 23 is different from the second modification (FIG. 18) in that a solid-state laser oscillator and an optical system for the solid-state laser oscillator are provided additionally. To be more specific, a solid-state laser oscillator 20, a condensing lens 21, two concave mirrors 6, a laser crystal 22, and a condensing lens 4.

As in the ninth embodiment, the semiconductor laser oscillator 1 is an GaAlAs laser that emits a laser beam having a wavelength of 810 nm and the solid-state laser oscillator 20 is an Nd:YAG laser or an Nd:YVO₄ laser that emits a coherent light beam having a wavelength of 1064 nm.

That end of the nonlinear optical crystal 5 which opposes the solid-state laser oscillator 20 has a coating that exhibits a high reflectance to the laser beam having a wavelength of 810 nm and a high transmittance to the laser beam having a wavelength of 1064 nm. The beam emitted from the solid-state laser oscillator 20 is therefore efficiently applied into the nonlinear optical crystal 5.

The laser beam emitted from the semiconductor laser oscillator 1 travels in the same way as in the second modification. On the other hand, the laser beam emitted from the solid-state laser oscillator 20 is applied to the nonlinear optical crystal 5 after passing through the condensing lens 21, concave mirror 6, laser crystal 22, concave mirror 6 and the condensing lens 4. As indicated above, said end of the nonlinear optical crystal 5 has a coating that exhibits a high reflectance to the 810 nm laser beam and a high transmittance to the 1064 nm laser beam. Therefore, the beam emitted from the solid-state laser oscillator 20 and having a wavelength of 1064 nm is applied to the nonlinear optical crystal 5. The nonlinearly optical crystal 5 mixes the 810 nm beam emitted from the semiconductor laser oscillator 1 with the 1064 nm beam emitted from the solid-state laser oscillator 20, generating a coherent beam having a wavelength of 460 nm. The 460 nm beam passes through the volume hologram 3 and is output to the external resonator.

Thus, the 810 nm beam emitted from the semiconductor laser oscillator 1 and the 1064 nm beam emitted from the solid-state laser oscillator 20 are subjected to frequency mixing. A coherent beam having a wavelength of 460 nm is thereby obtained.

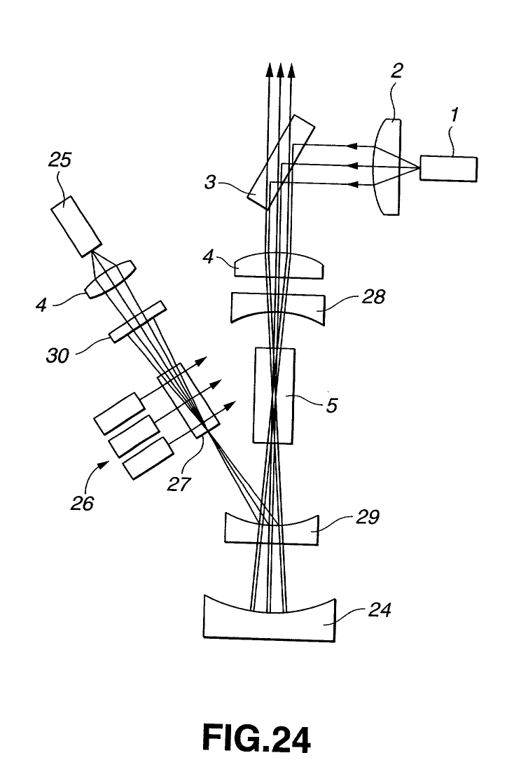

The eighth embodiment may be modified in another way, as is illustrated in FIG. 24, thus providing the seventh modification of the eighth embodiment (FIG. 14). In the seventh modification, the nonlinear optical crystal 5 can be located in the resonator common to the semiconductor laser oscillator 1 and the solid-state laser oscillator. In the seventh modification, the nonlinear optical crystal 5 may be KTP or the like.

As in the ninth embodiment, the semiconductor laser oscillator 1 is an GaAlAs laser that emits a laser beam having a wavelength of 810 nm and the solid-state laser oscillator is an Nd:YAG laser or an Nd:YVO₄ laser that emits a coherent light beam having a wavelength of 1064 nm.

The semiconductor laser oscillator 1 emits a laser beam. The collimator lens 2, volume hologram 3, condensing lens 4 and concave mirror 24 cooperate to generate, in the resonator, a coherent beam that has a wavelength of about 810 nm. A main end-pump exciting semiconductor laser 25 or auxiliary end-pump exciting semiconductor lasers 26 excite an Nd:YAG laser crystal 27, which generates light having a wavelength of 1064 nm. The resonator comprises concave mirrors 28 and 29 for processing the 1064 nm beam, the Nd:YAG laser crystal 27 and a flat mirror 30. The nonlinear optical crystal 5, which is located between the concave mirrors 28 and 29 for processing the 1064 nm beam, mixes the 810 nm beam emitted from the external resonator of the semiconductor laser oscillator 1 with the 1064 nm beam emitted from external resonator of the solid-state laser oscillator.

That is, the nonlinear optical crystal 5 mixes the 810 nm beam emitted from the semiconductor laser oscillator 1 with the 1064 nm beam emitted from the solid-state laser oscillator, generating a coherent beam having a wavelength of 460 nm. The 460 nm beam passes through the volume hologram 3 and is output to the external resonator.

The present invention can provide an external resonant semiconductor conductor laser which is simple in structure and which can be manufactured at low cost and operate in a stable transverse mode. Having transverse-mode selectivity, the laser can control the profile of the output beam. Further, the number of components of the laser can be decreased, because the astigmatism of the laser can be corrected and the divergence angle thereof can be controlled by means of a hologram. This helps to make the laser smaller and less expensive. Thus, the laser can be a low-cost light source.

The use ofthe external resonant semiconductor laser according to the invention is not limited to laser displays. Rather, it can be used in hologram wavelength-multiplex recording, data-recording apparatuses such as optical disc drives and hologram memories, wavelength-multiplex communication, wavelength conversion using nonlinear optical effect, laser cooling, frequency standardization, spectrometric measuring for controlling environment or processes, interferometers, and the like.

Thus, the 810 nm beam emitted from the semiconductor laser oscillator 1 and the 1064 nm beam emitted from the solid-state laser oscillator 20 are subjected to frequency mixing. A coherent beam having a wavelength of 460 nm is thereby obtained.

The blue beam having a wavelength of 460 nm, described above, is relatively perceptible to human eyes. It is desirable particularly when used together with a green beam and a red beam in a laser display. Hitherto it has been difficult to generate a laser beam of this wavelength at high efficiency and in high intensity. The method of this invention may of course be employed in a semiconductor laser or a solid-state laser to generate beams of other wavelengths.

The aging of the resonator is an inherent problem with the external resonant semiconductor lasers described above. The resonator length changes with time, due to vibration, temperature changes, air convection and the like. If the resonator length changes, the output of the laser will change. Nevertheless, this problem can be solved by various methods. More specifically, some measures are taken to minimize the vibration. The entire resonator may be shielded. The semiconductor laser may be mounted on a Peltier element to control the temperature. The input current to the semiconductor laser may be controlled. Some of the optical elements, such as a mirror, may be mounted on an actuator such as a piezoelectric element or a voice coil motor, thereby to move the optical elements to desired positions in accordance with feedback signals.

The beam used to record a hologram and the beam used to reproduce the hologram need not have the same wavelength. In view of Bragg's phase-matching condition, however, it is desired that both the reference beam and the object beam be plane waves in the process of reproducing the hologram. It may be desired that the beams used to record and reproduce a hologram, respectively, be different in wavelength and that waves other than plane waves be generated in the process of reproducing the hologram. In this case, it suffices to incorporate the recording optical system into a correction optical system. The correction optical system may comprise optical elements such as a hologram, a non-spherical optical element and an eccentric element. Alternatively, the correction optical system maybe a spatial modulator such as a diffraction optical element, a liquid crystal panel, or the like.

As described above, a volume hologram is used in the external resonator of any external resonant semiconductor laser according to the present invention. It is therefore possible to convert the wavelength of the laser beam at high efficiency. Thus, the laser can generate a laser beam in desired conditions.

The use of a volume hologram helps to reduce the number of components. This renders the laser simple, small, and reliable, and makes it possible to manufacture the laser at low cost. Furthermore, the efficiency of using light is enhanced, which minimizes the load on the light source and, hence, reduces the power consumption.

The external resonant semiconductor laser of the invention has an external resonator that incorporates a photopolymer volume hologram. The resonator can therefore exhibit high wavelength selectivity. This enables the laser to emit only waves that have lengths similar to a desired one. In other words, the laser emits a laser beam having a wavelength falling within a narrow range.

The photopolyiner volume hologram has a high diffraction efficiency. The laser can therefore emits a laser beam of any desired wavelength at high efficiency.

Moreover, the laser can generate a stable beam since the photopolymer volume hologram undergoes no aging.

Thus, the present invention can provide a laser which is simple and inexpensive and which can yet emit a laser beam having a wavelength falling within a narrow range.

What is claimed is:

1. An external resonant laser comprising:
a laser oscillator for emitting a laser beam of a specific wavelength; and
an external resonator for resonating the laser beam emitted from the laser oscillator,
wherein the external resonator contains a photopolymer volume hologram, and the photopolymer volume hologram diffracts the laser beam emitted from the laser oscillator, applies the laser beam into an optical system provided in the external resonator and allows the passage of a laser beam of a prescribed wavelength, thereby to output the laser beam of the prescribed wavelength from the external resonant laser.

2. The external resonant laser according to claim 1, wherein the photopolymer volume hologram is a reflex photopolymer volume hologram.

3. The external resonant laser according to claim 1, wherein the photopolymer volume hologram is a transmitting photopolymer volume hologram.

4. The external resonant laser according to claim 1, wherein the laser oscillator is a semiconductor laser oscillator.

5. The external resonant laser according to claim 1, wherein the optical system provided in the external resonator is a corner cube.

6. The external resonant laser according to claim 1, wherein the optical system provided in the external resonator is a reflection surface fonned on the photopolymer volume hologram.

7. The external resonant laser according to claim 1, wherein the optical system provided in the external resonator is a reflection surface on the photopolymer volume hologram, which is shaped like a corner cube.

8. The external resonant laser according to claim 1, wherein the photopolymer volume hologram is shaped like a collimator lens.

9. The external resonant laser according to claim 1, wherein the photopolymer volume hologram is arranged at a beam-emitting end of the laser oscillator.

10. The external resonant laser according to claim 1, wherein the external resonator contains a photopolymer volume hologram and a nonlinear optical crystal, the photopolymer volume hologram diffracts the laser beam emitted from the laser oscillator, applies the laser beam to the nonlinear optical crystal and allows the passage of a wavelength-converted laser beam, thereby to output the wavelength-converted laser beam from the external resonant laser.

11. The external resonant laser according to claim 1, wherein the volume hologram converts an aspect ratio of the laser beam emitted from the laser oscillator, thereby to adjust a cross section of the laser beam applied to the nonlinear optical crystal.

12. The external resonant laser according to claim 1, wherein the external resonator performs wavelength conversion by changing the laser beam emitted from the laser oscillator to second harmonic waves.

13. The external resonant laser according to claim 12, wherein the laser oscillator is an InGaAs laser for emitting a coherent beam having a wavelength of 920 nm, and the coherent beam is subjected to wavelength conversion and is thereby changed to second harmonic waves having a length of 460 nm.

14. The external resonant laser according to claim 1, further comprising a solid-state laser oscillator at the end opposite to the end from which a laser beam subjected to wavelength conversion is emitted, wherein the external resonator mixes the laser beam emitted fonn the laser oscillator and the laser beam emitted from the solid-state laser oscillator in terms of frequency in the external resonator, thereby to perfonn the wavelength conversion.

15. The external resonant laser according to claim 14, wherein the laser oscillator is a GaAlAs laser, the solid-state laser oscillator is an Nd:YAG laser or an Nd:YVO4 laser, and the laser beam emitted fonn the laser oscillator and having a wavelength of 810 nm and the laser beam emitted from the solid-state laser oscillator and having a wavelength of 1064 nm are mixed in terms of frequency, thereby to generate a coherent beam having a wavelength of 460 nm.
